(19) United States
(12) Patent Application Publication
(10) Pub. No.: US 2022/0375239 A1
(43) Pub. Date: Nov. 24, 2022

(54) SYSTEM AND METHODS TO OPTIMIZE YIELD IN INDOOR FARMING

(71) Applicants: Vishnu Agarwal, Haymarket, VA (US); Naman Agarwal, Haymarket, VA (US)

(72) Inventors: Vishnu Agarwal, Haymarket, VA (US); Naman Agarwal, Haymarket, VA (US)

(21) Appl. No.: 17/565,171

(22) Filed: Dec. 29, 2021

Related U.S. Application Data
(60) Provisional application No. 63/191,112, filed on May 20, 2021.

(51) Int. Cl. G06V 20/68; G06V 10/82; G06V 20/56; H04N 7/18; G06V 10/22; G06V 10/764; G06T 7/00

(52) U.S. Cl. CPC G06V 20/68; G06V 10/82; G06V 20/56; H04N 7/183; G06V 10/225; G06V 10/764; G06T 7/0012; G06T 2207/30004; G06T 2207/30188

(57) ABSTRACT

A method for detecting stressed plants in an indoor farm includes the steps of receiving two consecutively taken images of a plantation area in the indoor farm captured consecutively at a predetermined interval. The two images are combined to form a composite image. To the composite image is applied an object detection network to segment the composite image into images of single plants. Pre-trained convolution neuronal networks can be applied to the images of single plants classifying the single plants as healthy or stressed.

### CROSS-REFERENCE TO RELATED APPLICATIONS

This application claims priority from the U.S. provisional patent application Ser. No. 63/191,112, filed on May 20, 2021, which is incorporated herein by reference in its entirety.

### FIELD OF INVENTION

The present invention relates to indoor farming, and more particularly, the present invention relates to a machine learning based system and method to identify stressed plants in indoor farming and/or improve certain characteristics of the indoor plants.

### BACKGROUND

Indoor farming and vertical farming are poised to become an important part of the world's food supply as well as potentially help with greenhouse gases by bringing food growing closer to consumers. Indoor vertical farms, including hydroponics, are generally done in enclosed premises. In hydroponics, the soil is substituted with water and artificial light is used. Maintaining an indoor farm is a capital-intensive project and thus all efforts are made to improve the yields and prevent any crop loss. Moreover, indoor farming is a complex process that involves a combination of different parameters that has to be regulated within optimum limits to improve yield and prevent crop loss. Considering the cost, it is almost not practical to have humans monitor all parts of crops in the greenhouse. Thus, a desire is there for a system and method that can be used to monitor crops on an indoor farm.

### SUMMARY OF THE INVENTION

The following presents a simplified summary of one or more embodiments of the present invention in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a system and method for monitoring an indoor farm.

It is another object of the present invention that the system and method can identify stressed plants.

It is still another object of the present invention that the system and method can help to prevent crop losses.

It is yet another object of the present invention that the system and method provide for cost-effective monitoring of plant health and growth.

It is a further object of the present invention that timely action can be taken to prevent crop loss.

It is still a further object of the present invention that the system can make accurate predictions for plant health.

It is yet a further object of the present invention that human errors in assessing plant health can be avoided.

It is an additional object of the present invention that the system can be easily scaled up for large-scale indoor farming.

It is still an additional object of the present invention that the system and method can provide for improving yield of biomass or to improve specific quality of plant for flavor or potency.

It is yet an additional object of the present invention that the system and method can identify specific characteristics of leaves or flowers and feed that in either nutrient management and environment systems to further improve those characteristics.

In one aspect, the disclosed system includes a control unit that can receive images from multiple cameras. The disclosed system can provide for time series analysis of the received images to detect any abnormality in plants. In one case, the disclosed system can include machine learning-based classifiers to detect stressed plants, in near real-time and the output of the classification can be used by the nutrient management system and environment controller to further optimize conditions for best yield and quality.

In one aspect, the cameras can be stationary with respect to the plants, such as each camera can have in their view field a predefined plantation area. Alternatively, the cameras can be mobile, wherein the cameras can move along the racks to capture images of the plants along by, wherein bar codes or RFID tags can be used to identify the plantation area or zones, wherein the identification/location data can be combined to the metadata of the images.

In one aspect, disclosed is a method for detecting stressed plants in an indoor farm, the method implemented by a processor and a memory, the method includes the steps of receiving two consecutively taken images of a plantation area from a camera captured at a predetermined interval; combining the two images to form a composite image; apply an object detection network to the composite image to segment the composite image into images of single plants; and apply a plurality of pre-trained convolution neuronal networks to the images of single plants to classify single plants in the images of single plants as healthy or stressed.

In one implementation of the method, the predetermined interval is 24 hours. It is understood, however, that the predetermined time can be any duration. The method can further include the steps of determining a reason for the single plants getting stressed; generate a notification with the reason; and modifying one or more parameters of a nutrient management system and environment controller based on the reason. The object detection network can be configured to apply outlines around the single plants in the composite image, wherein the composite image is segmented along with the outlines. The plurality of pre-trained convolution neuronal networks determines a plurality of predictions for each plant in the images of single plants, and the method can further include the steps of calculating an average prediction vector from the plurality of predictions, wherein the single plants are classified as healthy or stressed based on the average prediction vector.

In one aspect, disclosed is a system for detecting stressed plants in an indoor farm, the system comprises a processor and a memory, wherein the processor and the memory configured to implement the disclosed method that can include the steps of receiving two consecutively taken images of a plantation area from a camera captured at a predetermined interval; combining the two images to form a composite image; apply an object detection network to the composite image to segment the composite image into images of single plants; and apply a plurality of pre-trained convolution neuronal networks to the images of single plants to classify single plants in the images of single plants as healthy or stressed.

In one aspect, disclosed is a method for indoor farming, the method implemented by a processor and a memory, the method includes the steps of mounting a camera to capture images of a plantation area; receiving two consecutively taken images of the plantation area from the camera captured at a predetermined interval; combining the two images to form a composite image; apply an object detection network to the composite image to segment the composite image into images of single plants; and apply a plurality of pre-trained convolution neuronal networks to the images of single plants to classify single plants in the images of single plants as healthy or stressed.

In one implementation of the method for indoor farming, the camera can be fixedly mounted nearby the plantation area. In one case, the camera can be mounted to a robotic arm, wherein the robotic arm is configured to move along a track running nearby the plantation area. The camera can be an RGB camera or a modified RGB camera with filters, and/or an IR Camera, or a specific camera purposefully designed to capture a set of specific wavelengths image and/or a combination of these cameras.

In one aspect, the disclosed system and method can further provide for improving the yield of biomass or improve any specific quality of plant for flavor or potency.

In one aspect, the system and method can further identify specific characteristics of leaves or flowers and feed that in either nutrient management and environment systems to further improve those characteristics.

These and other objects and advantages of the embodiments herein and the summary will become readily apparent from the following detailed description taken in conjunction with the accompanying drawings.

### BRIEF DESCRIPTION OF THE DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 is an environmental diagram showing the disclosed system connected to cameras, a display, and nutrient management system and environment controller, according to an exemplary embodiment of the present invention.

FIG. 2 is a block diagram showing the system architecture, according to an exemplary embodiment of the present invention.

FIG. 3 is a flow chart showing steps in the classification of plants using an average prediction vector, according to an exemplary embodiment of the present invention.

FIG. 4 is a flow chart showing steps for the classification of plants as healthy or stressed, according to an exemplary embodiment of the present invention.

FIG. 5 is a flow chart showing the inspection module, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely for the purpose of illustrating the general principles of the invention, since the scope of the invention will be best defined by the allowed claims of any resulting patent.

Disclosed is an automated system for classifying plants in indoor farming as healthy or stressed. The information from the disclosed system can be used in near-real time to take curative and precautionary steps to prevent crop loss and increase productivity. Lesser dependence on the human workforce makes the management process simple and cost-effective. The fields can be monitored at regular intervals by the disclosed system, such as in 24 hours intervals. Alerts can be generated by the system on detecting stressed plants and appropriate measures can also be optionally suggested by the system. In one case, the environment in indoor farming can also be micromanaged based on an output from the disclosed system.

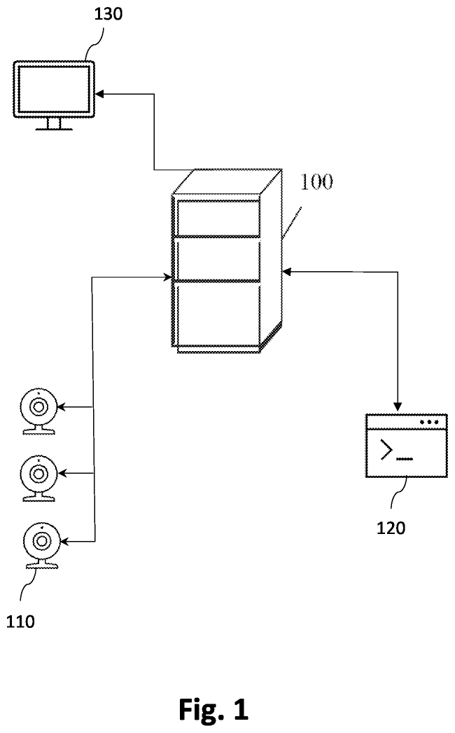

Referring to FIG. 1 which shows the disclosed system 100 in communication with the multiple cameras 110 that can be installed in the farming area. In one case, consumer-grade and cost-effective RGB cameras can be used for decreasing the implementation costs and such cameras are easily available. Other cameras including any specialized cameras can also be used and all such cameras and combinations of different cameras are within the scope of the present invention. In one case, the disclosed system 100 can use a combination of RGB cameras with other cameras such as Near IR and thermal cameras depending on specific needs. In one case, the camera can be a RGB camera or a modified RGB camera with filters, and/or an IR Camera, or a specific camera purposefully designed to capture a set of specific wavelengths image and/or a combination of these cameras.

The cameras can be installed in various locations to cover the plantation. For example, the cameras can be mounted above racks at regularly spaced intervals, such as each camera can capture a specific area of the rack, and consecutive cameras installed at regular intervals can cover the whole plantation. Thus, the cameras can be installed in any combination provided the objective of covering desired plantation area by the cameras can be achieved. An alternate to fixed cameras can be a mobile robot that can travel along with the racks and capture images of the plantation area. By this approach, a lesser number of cameras are needed and different types of cameras can be installed in the robot. The robot can be a wheeled robot that can move on the floor or tracks can be provided along with the rack on which a robotic arm can move and take photographs of the plantation area.

The disclosed system 100 can also be connected to a nutrient management system and environment controller 120. The nutrient management system and environment controller can manage both nutrition and microenvironment in the farm. The nutrient management system and environment controller is generally managed manually, wherein the user can define various values for different parameters to achieve desired nutrition levels and environment control. The disclosed system can tweak such values for the micromanagement of the plantation.

System 100 can also be connected to a display 130, wherein the users can interact with system 100 through the display. The users can define different parameters for the system 100 through an interface presented on the display. The interface can be in the form of a software application that can have controls for different components of the disclosed system 100. The user can view results, perform analysis, and view reports provided by the system 100 on the display 130. Moreover, the user can also view photographs of stressed plants taken over different time intervals.

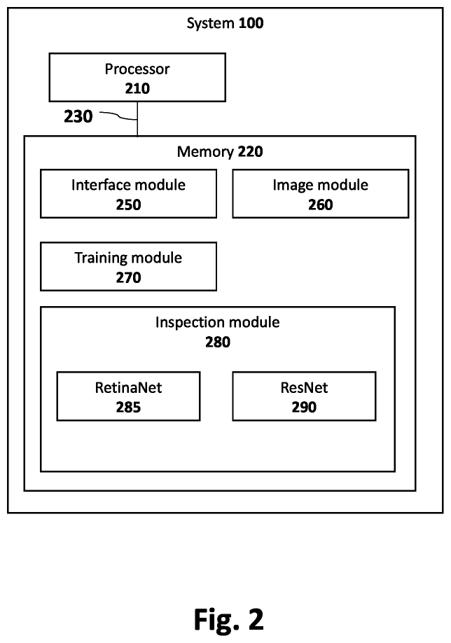

Referring to FIG. 2 which is a block diagram showing the architecture of the system 100. System 100 can include a processor 210 and a memory 220 connected through a system bus 130. The processor can be any logic circuitry that responds to, and processes instructions fetched from the memory 220. Suitable examples of the processors commercially available include Intel and AMD. The memory 220 may include one or more memory chips capable of storing data and allowing any storage location to be directly accessed by the processor 210. As shown in FIG. 2, the memory includes modules according to the present invention for execution by the processor 210 to perform one or more steps of the disclosed method for monitoring plant health in indoor farming. The memory 220 can include an interface module 250, an image module 260, a training module 270, and an inspection module 280. The inspection module can include RetinaNet 285 and ResNet 290.

The interface module 250 upon execution by the processor 210 can provide for an interface to allow for interaction of the user with the disclosed system. The interface can be provided as a software application that can be downloaded on a user device. The interface can receive inputs from the user and can present the results and reports to the user. The image module 260, upon execution by the processor, can provide for receiving images of the plantation from one or more cameras at predefined intervals. The image module 260 can also save the images with date and time information. The training module 270, upon execution by the processor, can provide for training the machine learning-based neuronal networks to distinguish between healthy and stressed plants using a training dataset. The inspection module 280, upon execution by the processor, can preprocess the images of plants and can classify single plants as healthy or stressed. The inspection module can include RetinaNet which is a known object detection network. It is to be understood that any other object detection networks known to a skilled person for isolating single plants in an image of plantation are within the scope of the present invention. To isolate single plants in an image of the plantation, the RetinaNet can apply outlines, such as a box around each plant and the image can be segmented along with the outlines into images of single plants. The inspection module can also include ResNet that is a group of convolution neuronal networks. ResNet or similar convolution neuronal networks can be trained to classify the plants as healthy or stressed.

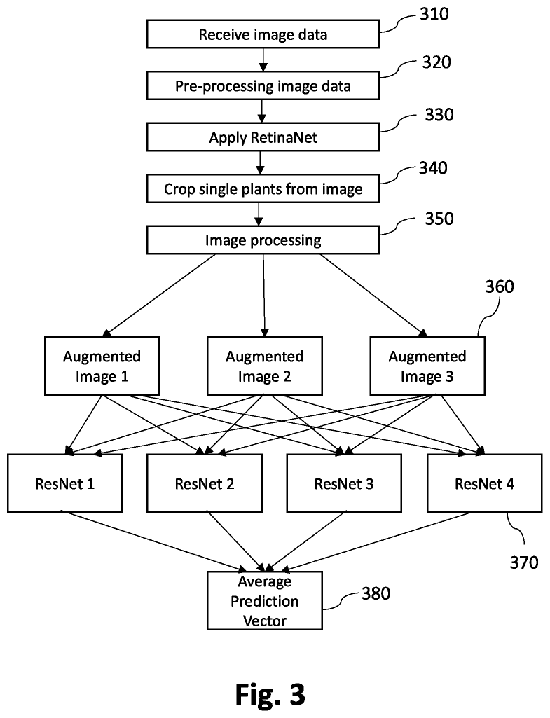

Referring to FIG. 3 which is a flow chart showing an exemplary embodiment of the disclosed method to classify plants as healthy or stressed. First, the disclosed system can receive images of different zones in the plantation from cameras installed in the indoor farm, at step 310. The metadata of the images can incorporate time and date information. The images can be pre-processed at step 320. Object detection networks, such as the Retina Net can then be applied to the pre-processed images to outline individual plants in the images, at step 330. The outline in the form of a box can be applied by the object detection networks around each plant in the images. The single plants based on the outline can be cropped from the images, at step 340. The images of single plants can then be processed, at step 350 and further augmentation, at step 360. The images of single plants can then be subjected to pre-trained neural networks, such as ResNet, at step 370. Each neural network in ResNet can provide a prediction. The average of predictions from each neural network of ResNet can be taken to obtain the average prediction factor, at step 380. The average prediction factor classifies the single plants into healthy or stressed.

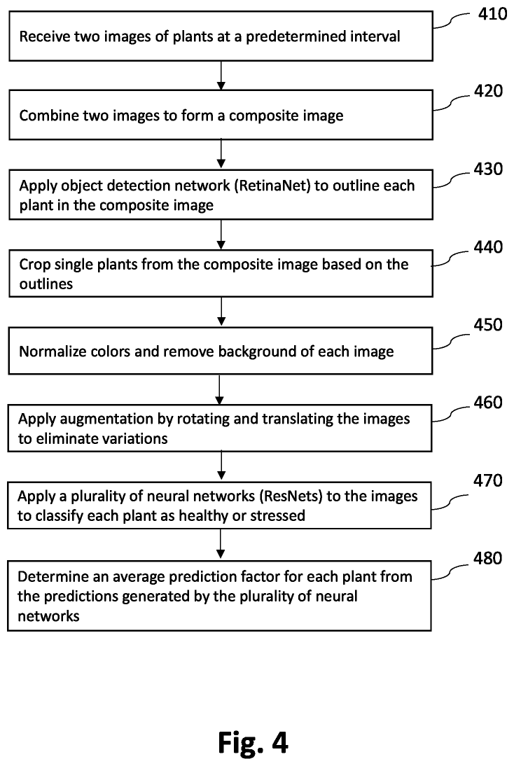

Referring to FIG. 4 which shows steps of disclosed method to classify plants as healthy or stressed. Two images of a plantation area can be taken at an interval by the cameras, at step 410. The interval can be predetermined based on a number of factors, such as the type of plants and the scale of farming. For example, images can be taken at an interval of 24 hours. It is understood, however, that the interval can be few minutes, hours, or days, and any such duration or period is within the scope of the present invention. Two consecutive images taken at a 24-hour interval can be combined to form a composite image, at step 420. To the composite image can be applied RetinaNet to mark outlines around single plants in the composite image, at step 430. The outlines can be in the form of a box of rectangular, square, or round shapes. The geometry of the outlines around single plants can depend upon the grouping and density of single plants in the image. Any object detection network can be used to outline single plants, and such object detection networks are within the scope of the present invention as along as the single plants in a composite image can be isolated. The composite image can then be segmented into images of single plants based on the outlines, at step 440. The images of single plants can further be processed by normalizing color and removing the background, at step 450. The images can be further subjected to augmentations that can modify the images slightly, at step 460. The augmentation can include rotation and translation of each image to improve model predictive accuracy by eliminating some of the variations. Thereafter, the images of single plants can be fed to ResNet wherein each convolution neural network in the ResNet can generate a prediction for the single plant, at step 470. An average of predictions from multiple neural networks of ResNet can be taken as the average prediction factor to classify the plant as healthy or stressed, at step 480.

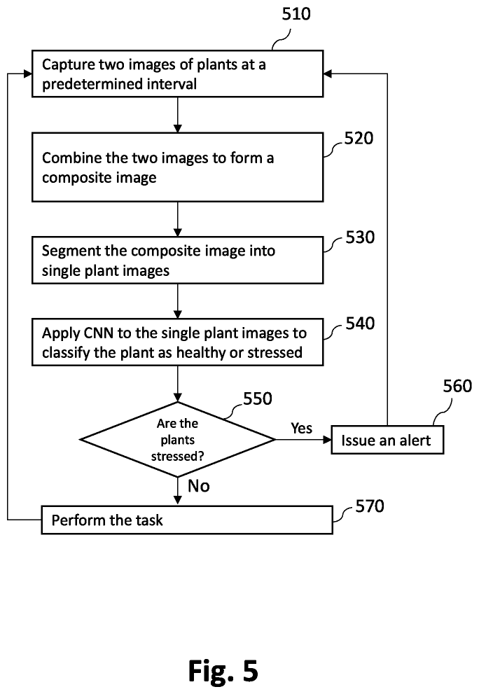

Referring to FIG. 5 which shows steps of a method to classify plants in indoor farming as healthy or stressed. The image module can trigger cameras to capture photographs of the plantation area at predetermined intervals. The predetermined interval can be defined through an interface generated by the interface module. The images can be stored with date and time information by the image module. The inspection module can receive two consecutive images taken at the predetermined interval, such as 24-hour, at step 510. Typically, the inspection module can receive the latest image and the image that is captured 24-hour earlier than the latest image. The two consecutively taken images can be combined by the inspection module to form a composite image 520. The plantation area generally includes several plants, and the size of the area depends on the view field of the camera. The plantation area can be an area of the plantation that can be captured by a single camera. Each of the composite images can be segmented into images of single plants by the inspection module, at step 530. Thereafter, pre-trained convolution neural networks can be applied to the images of single plants to classify the single plants as healthy or stressed, at step 540. The inspection module can then check if any stressed plants are present, at step 550. If the stressed plants are present, then an alert can be issued, at step 560. If no stressed plant can be found, the inspection module can perform a task if any defined through the interface module, at step 570.

In one case, the disclosed system can also determine reasons for the stressed plants, such as water loss or a sudden outbreak of a disease. In case any such reason could be found, the system can trigger an alert or notification. The system can also be connected to the nutrient management system and environment controller wherein any curative action can be taken by the nutrient management system and environment controller based on the information received from the inspection module regarding the reason behind stressed plants. Alternatively, the information can be manually fed into the nutrient management system and environment controller to optimize conditions for better yield and quality.

In one exemplary embodiment, by providing alerts when plants become stressed, the grower can take corrective actions before the plants become permanently damaged. It can prevent yield losses due to pests, water supply issues, and nutrient solution issues.

In one exemplary embodiment, the training dataset for training the convolution neural networks to classify the plants as healthy or stressed can be prepared with regular RGB cameras (the specific model in this case-Unifi g3 flex cameras). Two cameras were set up above the plants. And images of the plants were taken and saved at regular intervals to build a data set of images. As part of the training model, plants were stressed intentionally to collect images of unhealthy plants.

The disclosed system can further be configured to improve yield of biomass or improve specific quality of plant for flavor or potency. The system can identify specific characteristics of leaves or flowers, from the captured images and using the above-described algorithms and method and can suggest actions or measures to improve the identified characteristics. For example, in a mint plant, the color characteristic of the leave can be identified i.e., green colored, and accordingly, actions or measures can be taken to improve that the color characteristic by changing or adjusting the nutrient dose resulting in improved flavor by increasing potency of mint oil in leaves. In another example, for cannabis plants, characteristics, such as shape of flower and/or trichome shape, size, and quantity of flower can be identified, and trigger adjustment in nutrient/environmental factors input as well trigger human action such as trimming leaves around flower etc.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A method for detecting stressed plants in an indoor farm, the method implemented by a processor and a memory, the method comprising the steps of:
receiving two consecutively taken images of a plantation area from a camera captured at a predetermined interval;
combining the two images to form a composite image;
apply an object detection network to the composite image to segment the composite image into images of single plants; and
apply a plurality of pre-trained convolution neuronal networks to the images of single plants to classify single plants in the images of single plants as healthy or stressed.

2. The method according to claim 1, wherein the predetermined interval ranges from minutes to days.

3. The method according to claim 1, wherein the method further comprises the steps of:
determining a reason for the single plants getting stressed; and
generate a notification with the reason.

4. The method according to claim 3, wherein the method further comprises the steps of:
modifying one or more parameters of a nutrient management system and environment controller based on the reason.

5. The method according to claim 1, wherein the object detection network is configured to apply outlines around the single plants in the composite image, wherein the composite image is segmented along the outlines.

6. The method according to claim 1, wherein the plurality of pre-trained convolution neuronal networks determines a plurality of predictions for each plant in the images of single plants, and the method further comprises the steps of:
calculating an average prediction vector from the plurality of predictions,
wherein the single plants are classified as healthy or stressed based on the average prediction vector.

7. A system for detecting stressed plants in an indoor farm, the system comprises a processor and a memory, wherein the processor and the memory configured to implement a method comprising the steps of:
receiving two consecutively taken images of a plantation area from a camera captured at a predetermined interval;
combining the two images to form a composite image;
apply an object detection network to the composite image to segment the composite image into images of single plants; and
apply a plurality of pre-trained convolution neuronal networks to the images of single plants to classify single plants in the images of single plants as healthy or stressed.

8. The system according to claim 7, wherein the method further comprises the step of:
determining a reason for the single plants getting stressed; and
generate a notification with the reason.

9. The system according to claim 8, wherein the system further comprises a nutrient management system and environment controller, and the method further comprises the steps of:
modifying one or more parameters of the nutrient management system and environment controller based on the reason.

10. The system according to claim 7, wherein the object detection network is configured to apply outlines around the single plants in the composite image, wherein the composite image is segmented along the outlines.

11. The system according to claim 7, wherein the system comprises a camera for taking the images of the plantation area.

12. The system according to claim 11, wherein the camera is mounted to a wheeled robot.

13. The system according to claim 7, wherein the plurality of pre-trained convolution neuronal networks determines a plurality of predictions for each plant in the images of single plants, and the method further comprises the steps of:
calculating an average prediction vector from the plurality of predictions,
wherein the single plants are classified as healthy or stressed based on the average prediction vector.

14. A method for indoor farming, the method implemented by a processor and a memory, the method comprising the steps of:
mounting a camera to capture images of a plantation area;
receiving two consecutively taken images of the plantation area from the camera captured at a predetermined interval;
combining the two images to form a composite image;
apply an object detection network to the composite image to segment the composite image into images of single plants; and
apply a plurality of pre-trained convolution neuronal networks to the images of single plants to classify single plants in the images of single plants as healthy or stressed.

15. The method according to claim 14, wherein the camera is fixedly mounted nearby the plantation area.

16. The method according to claim 14, wherein the camera is mounted to a robotic arm, wherein the robotic arm is configured to move along a track running nearby the plantation area.

17. The method according to claim 14, wherein the camera is selected from a group consisting of a RGB camera, a modified RGB camera with filters, an IR Camera, a customized camera configured to capture a set of specific wavelengths image, or a combination thereof.

18. The method according to claim 8, wherein the method further comprises the steps of:
identifying specific characteristics of the single plants from the composite image;
determine measures and/or actions to manipulate the said specific characteristics; and
monitoring changes in said specific characteristics.

19. The method according to claim 18, wherein the specific features comprise color of leaves, and the measures and/or actions comprise manipulating nutrition dose for the plantation area.
